(19) United States
(12) Patent Application Publication
(10) Pub. No.: US 2020/0322904 A1
(43) Pub. Date: Oct. 8, 2020

(54) TECHNIQUES AND APPARATUSES FOR TRACKING AREA SYNCHRONIZATION

(71) Applicant: QUALCOMM INCORPORATED, San Diego, CA (US)

(72) Inventors: Liying HOU, Beijing (CN); Yinming LIANG, Beijing (CN); Alvin Siu-Chung NG, Beijing (CN)

(73) Assignee: Qualcomm Incorporated, San Diego, CA (US)

(21) Appl. No.: 16/303,619

(22) PCT Filed: Sep. 2, 2016
(86) PCT No.: PCT/CN2016/097891

§ 371 Date: Nov. 20, 2018

(30) Foreign Application Priority Data
Jun. 27, 2016 (CN) PCT/CN2016/087266

(51) Int. Cl. H04W 56/00; H04W 64/00; H04B 17/318; H04L 29/06

(52) U.S. Cl. CPC H04W 56/001; H04L 69/28; H04B 17/318; H04W 64/00

(57) ABSTRACT

Certain aspects of the present disclosure generally relate to wireless communications. In some aspects, a wireless communication device may determine, based on a tracking area update (TAU) accept message that a tracking area is out of synchronization. In some aspects, the wireless communication device may trigger, after expiration of a timer, a TAU procedure based on determining that the tracking area is out of synchronization. Numerous other aspects are provided.

### CROSS-REFERENCE TO RELATED APPLICATION

This application claims priority to PCT Application No. PCT/CN2016/087266 filed on Jun. 27, 2016 entitled “TECHNIQUES AND APPARATUSES FOR TRACKING AREA SYNCHRONIZATION,” which is incorporated by reference herein.

### FIELD OF THE DISCLOSURE

Aspects of the present disclosure generally relate to wireless communications, and more particularly to techniques and apparatuses for tracking area synchronization, for example, techniques and apparatuses for triggering, after expiration of a timer, a tracking area update (TAU) procedure based on determining that a tracking area is out of synchronization to cause the tracking area to be synchronized.

### BACKGROUND

Wireless communication systems are widely deployed to provide various telecommunication services, such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, a national, a regional, and even a global level. An example of a telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, using new spectrum, and integrating with other open standards using OFDMA on the downlink (DL), SC-FDMA on the uplink (UL), and multiple-input multiple-output (MIMO) antenna technology.

### SUMMARY

In some aspects, a method of wireless communication may include determining, by a wireless communication device and based on a tracking area update (TAU) accept message, that a tracking area is out of synchronization. The method may include triggering, by the wireless communication device and after expiration of a timer, a TAU procedure based on determining that the tracking area is out of synchronization.

In some aspects, a wireless communication device may include one or more processors configured to determine, based on a tracking area update (TAU) accept message, that a tracking area is out of synchronization. The one or more processors may be configured to trigger, after expiration of a timer, a TAU procedure based on determining that the tracking area is out of synchronization.

In some aspects, a non-transitory computer-readable medium may store one or more instructions for wireless communication. The one or more instructions may include one or more instructions that, when executed by one or more processors of a wireless communication device, cause the one or more processors to determine, based on a tracking area update (TAU) accept message, that a tracking area is out of synchronization. The one or more instructions may cause the one or more processors to trigger, after expiration of a timer, a TAU procedure based on determining that the tracking area is out of synchronization.

In some aspects, an apparatus for wireless communication may include means for determining, based on a tracking area update (TAU) accept message, that a tracking area is out of synchronization. The apparatus may include means for triggering, after expiration of a timer, a TAU procedure based on determining that the tracking area is out of synchronization.

Aspects generally include a method, wireless communication device, computer program product, non-transitory computer-readable medium (e.g., for storing instructions), and user equipment (UE), as substantially described herein with reference to and as illustrated by the accompanying drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example deployment in which multiple wireless networks have overlapping coverage, in accordance with various aspects of the present disclosure.

FIG. 2 is a diagram illustrating an example access network in an LTE network architecture, in accordance with various aspects of the present disclosure.

FIG. 3 is a diagram illustrating an example of a downlink frame structure in LTE, in accordance with various aspects of the present disclosure.

FIG. 4 is a diagram illustrating an example of an uplink frame structure in LTE, in accordance with various aspects of the present disclosure.

FIG. 5 is a diagram illustrating an example of a radio protocol architecture for a user plane and a control plane in LTE, in accordance with various aspects of the present disclosure.

FIG. 6 is a diagram illustrating example components of an evolved Node B and a user equipment in an access network, in accordance with various aspects of the present disclosure.

FIGS. 7A and 7B are diagrams of an overview of an exemplary aspect described herein, in accordance with various aspects of the present disclosure.

FIG. 8 is a diagram illustrating an example process performed, for example, by a wireless communication device, in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for providing a thorough understanding of the various concepts. However, it will be apparent to those skilled in the art that these concepts may be practiced without these specific details.

The techniques described herein may be used for one or more of various wireless communication networks such as code division multiple access (CDMA) networks, time division multiple access (TDMA) networks, frequency division multiple access (FDMA) networks, orthogonal FDMA (OFDMA) networks, single carrier FDMA (SC-FDMA) networks, or other types of networks. A CDMA network may implement a radio access technology (RAT) such as universal terrestrial radio access (UTRA), CDMA2000, and/or the like. UTRA may include wideband CDMA (WCDMA) and/or other variants of CDMA. CDMA2000 may include Interim Standard (IS)-2000, IS-95 and IS-856 standards. IS-2000 may also be referred to as 1× radio transmission technology (1×RTT), CDMA2000 1×, and/or the like. A TDMA network may implement a RAT such as global system for mobile communications (GSM), enhanced data rates for GSM evolution (EDGE), or GSM/EDGE radio access network (GERAN). An OFDMA network may implement a RAT such as evolved UTRA (E-UTRA), ultra mobile broadband (UMB), Institute of Electrical and Electronics Engineers (IEEE) 802.11 (Wi-Fi), IEEE 802.16 (WiMAX), IEEE 802.20, Flash-OFDM, and/or the like. UTRA and E-UTRA may be part of the universal mobile telecommunication system (UMTS). 3GPP long-term evolution (LTE) and LTE-Advanced (LTE-A) are example releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and RATs mentioned above as well as other wireless networks and RATs.

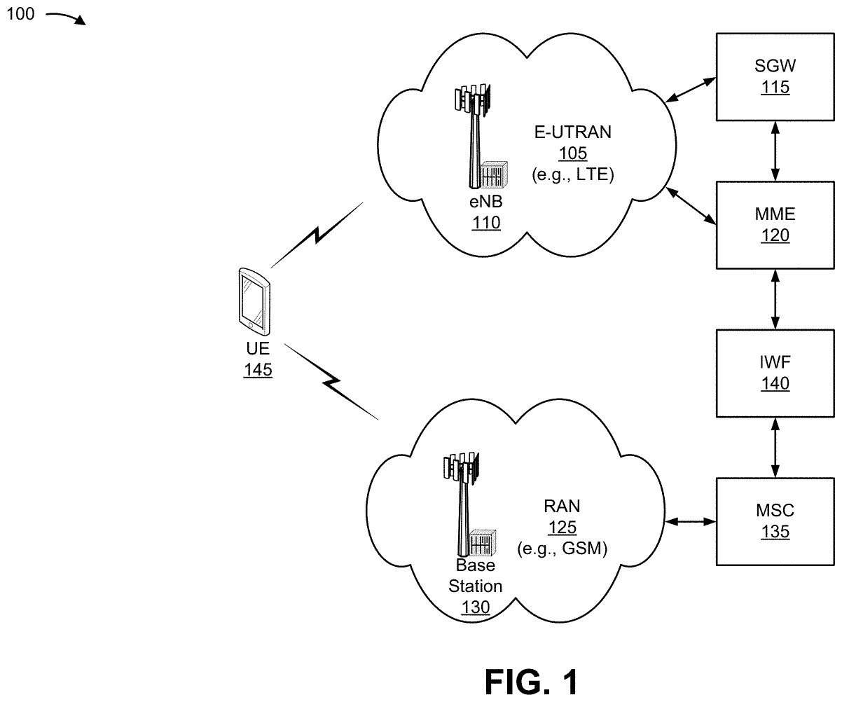

FIG. 1 is a diagram illustrating an example deployment 100 in which multiple wireless networks have overlapping coverage, in accordance with various aspects of the present disclosure. As shown, example deployment 100 may include a first radio access network (RAN), such as an evolved universal terrestrial radio access network (E-UTRAN) 105, which may include one or more evolved Node Bs (eNBs) 110, and which may communicate with other devices or networks via a serving gateway (SGW) 115 and/or a mobility management entity (MME) 120. As further shown, example deployment 100 may include a second RAN 125, which may include one or more base stations 130, and which may communicate with other devices or networks via a mobile switching center (MSC) 135 and/or an inter-working function (IWF) 140. As further shown, example deployment 100 may include one or more user equipments (UEs) 145 capable of communicating via E-UTRAN 105 and/or RAN 125.

E-UTRAN 105 may support, for example, LTE or another type of RAT. E-UTRAN 105 may include eNBs 110 and other network entities that can support wireless communication for UEs 145. Each eNB 110 may provide communication coverage for a particular geographic area. The term “cell” may refer to a coverage area of eNB 110 and/or an eNB subsystem serving the coverage area.

SGW 115 may communicate with E-UTRAN 105 and may perform various functions, such as packet routing and forwarding, mobility anchoring, packet buffering, initiation of network-triggered services, and/or the like. MME 120 may communicate with E-UTRAN 105 and SGW 115 and may perform various functions, such as mobility management, bearer management, distribution of paging messages, security control, authentication, gateway selection, and/or the like, for UEs 145 located within a geographic region served by MME 120 of E-UTRAN 105. In some aspects, MME 120 may utilize tracking area information identifying a tracking area of UE 145 to direct paging messages and/or the like toward UE 145. The network entities in LTE are described in 3GPP TS 36.300, entitled “Evolved Universal Terrestrial Radio Access (E-UTRA) and Evolved Universal Terrestrial Radio Access Network (E-UTRAN); Overall description,” which is publicly available.

RAN 125 may support, for example, GSM or another type of RAT. RAN 125 may include base stations 130 and other network entities that can support wireless communication for UEs 145. MSC 135 may communicate with RAN 125 and may perform various functions, such as voice services, routing for circuit-switched calls, and mobility management for UEs 145 located within a geographic region served by MSC 135 of RAN 125. In some aspects, IWF 140 may facilitate communication between MME 120 and MSC 135 (e.g., when E-UTRAN 105 and RAN 125 use different RATs). Additionally, or alternatively, MME 120 may communicate directly with an MME that interfaces with RAN 125, for example, without IWF 140 (e.g., when E-UTRAN 105 and RAN 125 use a common RAT). In some aspects, E-UTRAN 105 and RAN 125 may use a common frequency and/or a common RAT to communicate with UE 145. In some aspects, E-UTRAN 105 and RAN 125 may use different frequencies and/or different RATs to communicate with UEs 145.

In general, any number of wireless networks may be deployed in a given geographic area. Each wireless network may support a particular RAT and may operate on one or more frequencies. A RAT may also be referred to as a radio technology, an air interface, and/or the like. A frequency or frequency ranges may also be referred to as a carrier, a frequency channel, and/or the like. Each frequency or frequency range may support a single RAT in a given geographic area in order to avoid interference between wireless networks of different RATs.

UE 145 may be stationary or mobile and may also be referred to as a mobile station, a terminal, an access terminal, a wireless communication device, a subscriber unit, a station, a device, and/or the like. UE 145 may be a cellular phone, a personal digital assistant (PDA), a wireless modem, a wireless communication device, a handheld device, a laptop computer, a cordless phone, a wireless local loop (WLL) station, and/or the like.

Upon power up, UE 145 may search for wireless networks from which UE 145 can receive communication services. If UE 145 detects more than one wireless network, then a wireless network with the highest priority may be selected to serve UE 145 and may be referred to as the serving network. UE 145 may perform registration with the serving network, if necessary. UE 145 may then operate in a connected mode to actively communicate with the serving network. Alternatively, UE 145 may operate in an idle mode and camp on the serving network if active communication is not required by UE 145.

UE 145 may operate in the idle mode as follows. UE 145 may identify all frequencies/RATs on which it is able to find a “suitable” cell in a normal scenario or an “acceptable” cell in an emergency scenario, where “suitable” and “acceptable” are specified in the LTE standards. UE 145 may then camp on the frequency/RAT with the highest priority among all identified frequencies/RATs. UE 145 may remain camped on this frequency/RAT until either (i) the frequency/RAT is no longer available at a predetermined threshold or (ii) another frequency/RAT with a higher priority reaches this threshold. In some aspects, UE 145 may receive a neighbor list when operating in the idle mode, such as a neighbor list included in a system information block type 5 (SIB 5) provided by an eNB of a RAT on which UE 145 is camped. Additionally, or alternatively, UE 145 may generate a neighbor list. A neighbor list may include information identifying one or more frequencies, at which one or more RATs may be accessed, priority information associated with the one or more RATs, and/or the like.

A tracking area update procedure may be utilized to ensure that paging messages are directed to a correct tracking area. For example, UE 145 may periodically trigger a tracking area update to provide confirmation of the tracking area in which UE 145 is operating and to ensure that information is directed toward UE 145, such as paging messages, signaling information, and/or the like. Similarly, when UE 145 transfers from a first tracking area to a second tracking area, UE 145 may initiate a tracking area update.

UE 145 may transmit a first tracking area update request message to initiate a tracking area update procedure based on determining that a threshold amount of time from a previous tracking area update has elapsed. The first tracking area update request message may be directed toward MME 120, for example, via eNB 110, base station 130, and/or the like. MME 120 may provide a first tracking area update accept message to confirm the tracking area to which UE 145 is registered. However, before UE 145 receives the first tracking area update accept message, UE 145 may transfer from a first tracking area to a second tracking area. In this case, UE 145 may transmit a second tracking area update request to indicate that UE 145 is located in the second tracking area.

In some aspects, UE 145 may receive a tracking area update reject message associated with a back-off timer, which may cause UE 145 to delay an attempt to initiate another tracking area update. For example, MME 120 may cause UE 145 to trigger the back-off timer based on receiving the tracking area update reject message relating to a frequency with which UE 145 is permitted to initiate a tracking area update, relating to a loss of network connectivity, or the like, and may attempt to initiate another tracking area update after expiration of the back-off timer.

UE 145 may receive the first tracking area update accept message associated with the first tracking area update request. UE 145 may transfer from a first protocol state (e.g., a first UE tracking area state) associated with the tracking area update procedure to a second protocol state (e.g., a second UE tracking area state) not associated with the tracking area update procedure based on receiving the first tracking area update accept message. MME 120 may transmit one or more second tracking area update accept messages associated with the second tracking area update request. However, based on transferring from the first protocol state to the second protocol state, UE 145 may reject the one or more second tracking area update accept messages. Based on UE 145 rejecting the one or more second tracking area update accept messages, MME 120 may fail to register UE 145 in the second tracking area. In this case, the tracking area may be out of synchronization (e.g., there is a mismatch between the tracking area the UE associates with the UE, and tracking area the network associates with the UE), which may cause UE 145 to fail to receive one or more paging messages that MME 120 transmits. Moreover, a user of UE 145 may experience degraded network performance when using UE 145 based on the tracking area of UE 145 being out of synchronization with MME 120.

UE 145 may perform tracking area synchronization, for example, based on determining that the tracking area is out of synchronization. For example, UE 145 may determine that the tracking area is out of synchronization based on determining that a first tracking area identifier of the first tracking area update accept message does not match a second tracking area identifier associated with and/or included in a system information block type 1 (SIB1) message. In this case, UE 145 may trigger, for example, after expiration of a timer (a timer triggered based on receiving a tracking area update accept message and based on determining that the tracking area is out of synchronization), another tracking area update procedure based on determining that the tracking area is out of synchronization. For example, UE 145 may transfer to the first protocol state, transmit the other tracking area update request message, and may receive another tracking area update accept message.

In this way, the present methods and apparatuses may ensure that when a UE 145 ends a tracking area update procedure based on receiving the first tracking area update accept message as described above, the UE 145 tracking area does not remain out of synchronization (e.g., for a prolonged time), thereby reducing a likelihood of UE 145 failing to receive a page from MME 120 and/or improving network performance associated with UE 145. Moreover, the UE 145 may reduce network traffic based on avoiding causing MME 120 to transmit multiple tracking area update accept messages that are rejected and/or one or more paging messages that are not received by UE 145.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

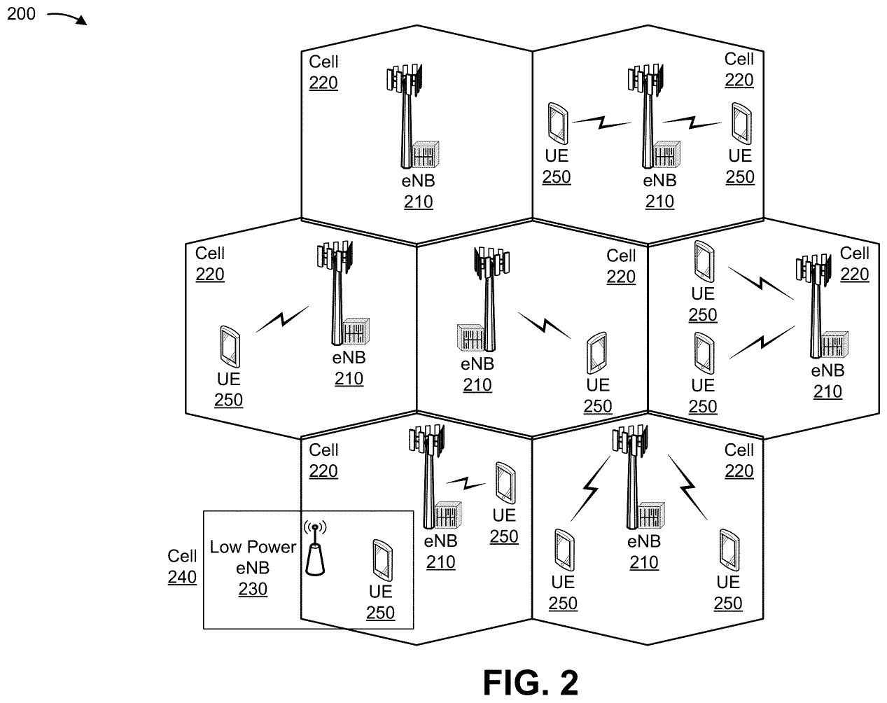

FIG. 2 is a diagram illustrating an example access network 200 in an LTE network architecture, in accordance with various aspects of the present disclosure. As shown, access network 200 may include one or more eNBs 210 that serve a corresponding set of cellular regions (cells) 220, one or more low power eNBs 230 that serve a corresponding set of cells 240, and a set of UEs 250.

Each eNB 210 may be assigned to a respective cell 220 and may be configured to provide an access point to a RAN. For example, eNB 110, 210 may provide an access point for UE 145, 250 to E-UTRAN 105 (e.g., eNB 210 may correspond to eNB 110, shown in FIG. 1) or may provide an access point for UE 145, 250 to RAN 125 (e.g., eNB 210 may correspond to base station 130, shown in FIG. 1). UE 145, 250 may correspond to UE 145, shown in FIG. 1. FIG. 2 does not illustrate a centralized controller for example access network 200, but access network 200 may use a centralized controller in some aspects. The eNBs 210 may perform radio related functions including radio bearer control, admission control, mobility control, scheduling, security, and network connectivity (e.g., to SGW 115).

As shown in FIG. 2, one or more low power eNBs 230 may serve respective cells 240, which may overlap with one or more cells 220 served by eNBs 210. The eNBs 230 may correspond to eNB 110 associated with E-UTRAN 105 and/or base station 130 associated with RAN 125, shown in FIG. 1. A low power eNB 230 may be referred to as a remote radio head (RRH). The low power eNB 230 may include a femto cell eNB (e.g., home eNB (HeNB)), a pico cell eNB, a micro cell eNB, and/or the like.

UE 145, 250 may initiate a first tracking area update procedure when, for example, operating in a first tracking area associated with a first cell 220 and/or a first eNB 110, 210, 230. After transferring from the first tracking area to a second tracking area associated with a second cell 220 and/or a second eNB 110, 210, 230, UE 145, 250 may initiate a second tracking area update procedure to cause MME 120 to register UE 145, 250 in the second tracking area. UE 145, 250 may receive a tracking area update accept message based on initiating the first tracking area update procedure and after initiating the second tracking area update procedure, and may terminate the second tracking area update procedure based on receiving the tracking area update accept message.

In this case, UE 145, 250 may determine that a tracking area identifier of the tracking area update accept message is associated with the first tracking area rather than the second tracking area. UE 145, 250 may trigger a timer and, after determining that a threshold period of time associated with the timer has expired, UE 145, 250 may trigger a third tracking area update procedure. UE 145, 250 may receive another tracking area update accept message after triggering the third tracking area update procedure, and may synchronize the tracking area (e.g., synchronize the tracking area the UE associates with the UE and the tracking area the network associates with the UE) based on receiving the other tracking area update accept message. In this way, UE 145, 250 synchronizes a tracking area, thereby reducing a likelihood of UE 145, 250 failing to receive a paging message and/or experiencing degraded network performance relative to allowing the tracking area to remain out of synchronization.

A modulation and multiple access scheme employed by access network 200 may vary depending on the particular telecommunications standard being deployed. In LTE applications, OFDM is used on the downlink (DL) and SC-FDMA is used on the uplink (UL) to support both frequency division duplexing (FDD) and time division duplexing (TDD). The various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. As another example, these concepts may also be extended to UTRA employing WCDMA and other variants of CDMA (e.g., such as TD-SCDMA, GSM employing TDMA, E-UTRA, and/or the like), UMB, IEEE 802.11 (Wi-Fi), IEEE 802.16 (WiMAX), IEEE 802.20, Flash-OFDM employing OFDMA, and/or the like. UTRA, E-UTRA, UMTS, LTE, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 110, 210, 230 may have multiple antennas supporting MIMO technology. The use of MIMO technology enables eNBs 110, 210, 230 to exploit the spatial domain to support spatial multiplexing, beamforming, and transmit diversity. Spatial multiplexing may be used to transmit different streams of data simultaneously on the same frequency. The data streams may be transmitted to a single UE 145, 250 to increase the data rate or to multiple UEs 250 to increase the overall system capacity. This may be achieved by spatially precoding each data stream (e.g., applying a scaling of an amplitude and a phase) and then transmitting each spatially precoded stream through multiple transmit antennas on the DL. The spatially precoded data streams arrive at the UE(s) 250 with different spatial signatures, which enables each of the UE(s) 250 to recover the one or more data streams destined for that UE 145, 250. On the UL, each UE 145, 250 transmits a spatially precoded data stream, which enables eNBs 110, 210, 230 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR), which is sometimes referred to as a PAR value.

The number and arrangement of devices and cells shown in FIG. 2 are provided as an example. In practice, there may be additional devices and/or cells, fewer devices and/or cells, different devices and/or cells, or differently arranged devices and/or cells than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

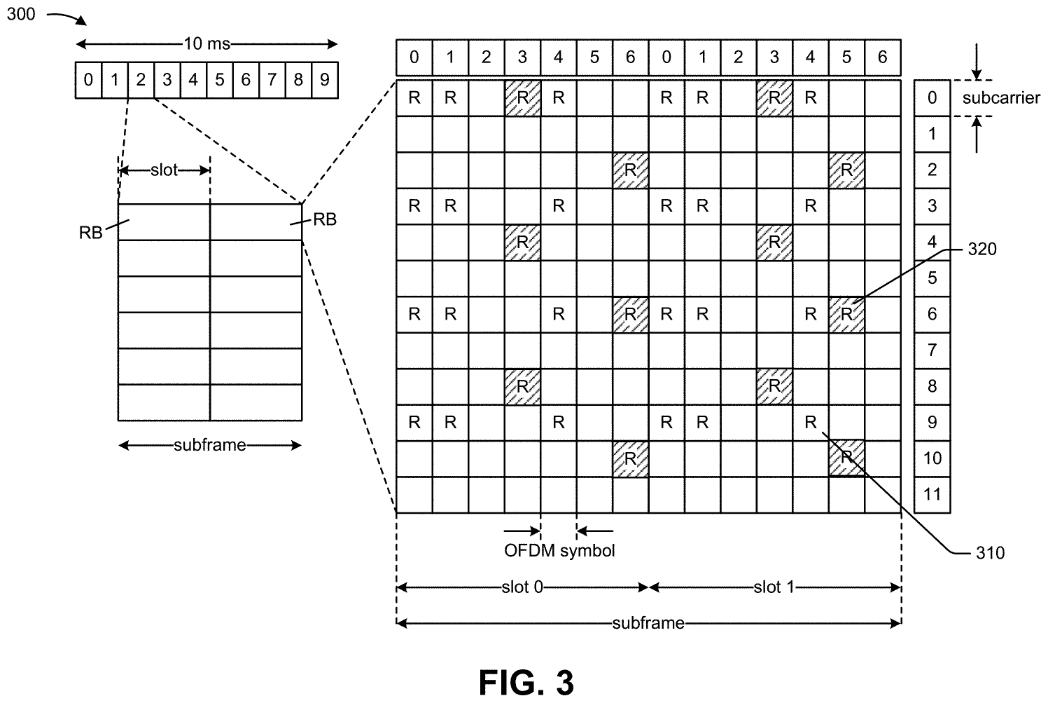

FIG. 3 is a diagram illustrating an example 300 of a downlink (DL) frame structure in LTE, in accordance with various aspects of the present disclosure. A frame (e.g., of 10 ms) may be divided into 10 equally sized sub-frames with indices of 0 through 9. Each sub-frame may include two consecutive time slots. A resource grid may be used to represent two time slots, each time slot including a resource block (RB). The resource grid is divided into multiple resource elements. In LTE, a resource block includes 12 consecutive subcarriers in the frequency domain and, for a normal cyclic prefix in each OFDM symbol, 7 consecutive OFDM symbols in the time domain, or 84 resource elements. For an extended cyclic prefix, a resource block includes 6 consecutive OFDM symbols in the time domain and has 72 resource elements. Some of the resource elements, as indicated as R 310 and R 320, include DL reference signals (DL-RS). The DL-RS include Cell-specific RS (CRS) (also sometimes called common RS) 310 and UE-specific RS (UE-RS) 320. UE-RS 320 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2, or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

UE 145, 250 may receive information from eNB 110, 210, 230 via a DL frame, as described herein. For example, UE 145, 250 may receive a tracking area update accept message, and may determine that a tracking area is out of synchronization based on information included in the DL frame such as, for example, a tracking area identifier, a SIB1 message, and/or the like. UE 145, 250 may trigger a tracking area update procedure based on determining that the tracking area is out of synchronization. For example, UE 145, 250 may transmit a tracking area update request message, and may receive, via another DL frame, a tracking area update accept message to synchronize the tracking area for UE 145, 250 (e.g., synchronize the tracking area the UE associates with the UE with the tracking area the network associates with the UE). In this way, UE 145, 250 reduces a likelihood of failing to receive a paging message and experiencing degraded network performance relative to allowing the tracking area to remain out of synchronization.

As indicated above, FIG. 3 is provided as an example. Other examples are possible and may differ from what was described above in connection with FIG. 3.

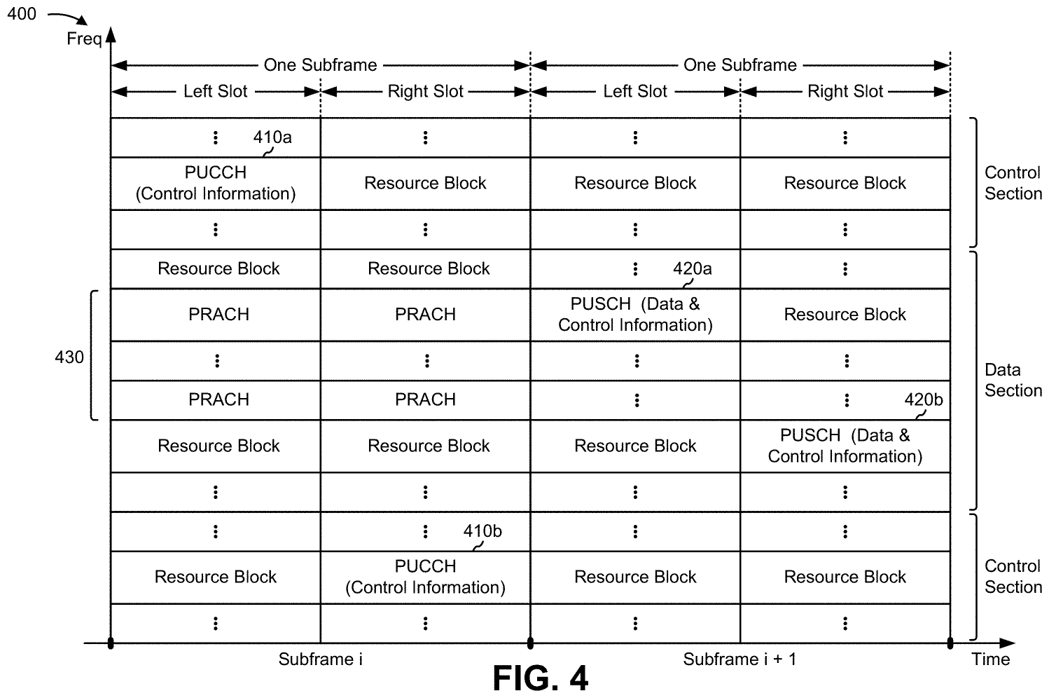

FIG. 4 is a diagram illustrating an example 400 of an uplink (UL) frame structure in LTE, in accordance with various aspects of the present disclosure. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequencies.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (e.g., of 1 ms) or in a sequence of few contiguous subframes and a UE can make only a single PRACH attempt per frame (e.g., of 10 ms).

UE 145, 250 may transmit one or more signals via a UL frame, as described herein. For example, UE 145, 250 may transmit a first tracking area update request message and/or a second tracking area update request message via a set of UL frames. UE 145, 250 may receive a tracking area update accept message based on transmitting the first tracking area update request message and after transmitting the second tracking area update request message, and may determine that a tracking area is out of synchronization. UE 145, 250 may trigger, after expiration of a timer, a tracking area update procedure based on determining that the tracking area is out of synchronization. For example, UE 145, 250 may transmit a third tracking area update request message to trigger the tracking area update procedure and synchronize the tracking area. In this way, UE 145, 250 reduces a likelihood of failing to receive one or more paging messages from MME 120 and/or experiencing degraded network performance relative to permitting the tracking area to remain out of synchronization.

As indicated above, FIG. 4 is provided as an example. Other examples are possible and may differ from what was described above in connection with FIG. 4.

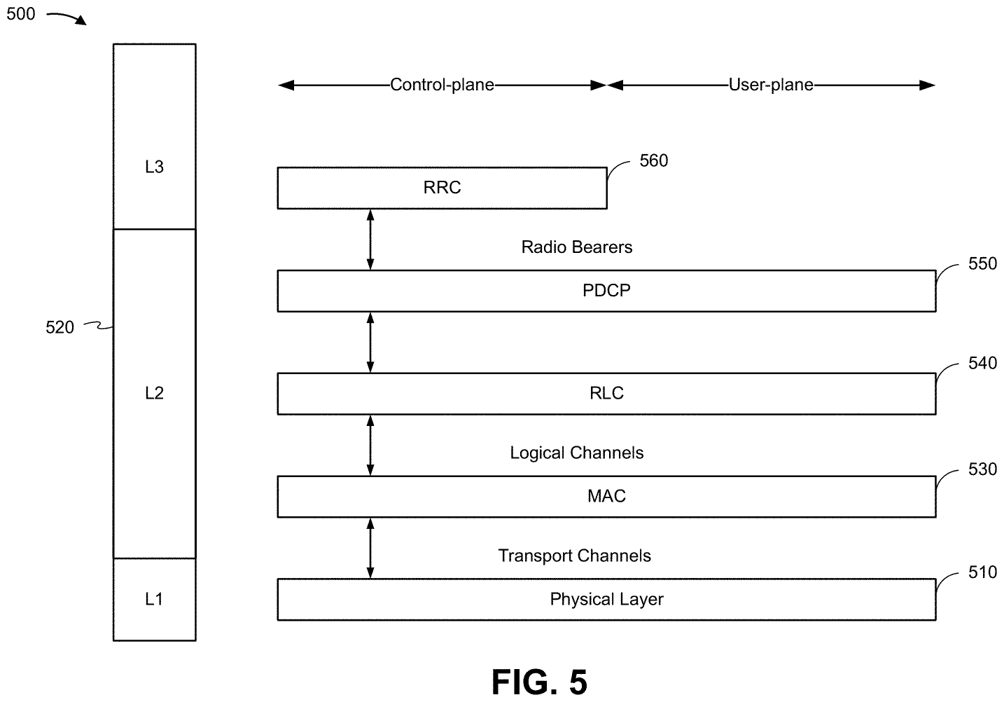

FIG. 5 is a diagram illustrating an example 500 of a radio protocol architecture for a user plane and a control plane in LTE, in accordance with various aspects of the present disclosure. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 510. Layer 2 (L2 layer) 520 is above the physical layer 510 and is responsible for the link between the UE and eNB over the physical layer 510.

In the user plane, the L2 layer 520, for example, includes a media access control (MAC) sublayer 530, a radio link control (RLC) sublayer 540, and/or a packet data convergence protocol (PDCP) 550 sublayer, which are terminated at the eNB on the network side. Although not shown, the UE may have several upper layers above the L2 layer 520 including a network layer (e.g., IP layer) that is terminated at a packet data network (PDN) gateway on the network side, and an application layer that is terminated at the other end of the connection (e.g., far end UE, server, and/or the like).

The PDCP sublayer 550 provides multiplexing between different radio bearers and logical channels. The PDCP sublayer 550 also provides header compression for upper layer data packets to reduce radio transmission overhead, security by ciphering the data packets, and handover support for UEs between eNBs. The RLC sublayer 540 provides segmentation and reassembly of upper layer data packets, retransmission of lost data packets, and reordering of data packets to compensate for out-of-order reception due to hybrid automatic repeat request (HARQ). The MAC sublayer 530 provides multiplexing between logical and transport channels. The MAC sublayer 530 is also responsible for allocating the various radio resources (e.g., resource blocks) in one cell among the UEs. The MAC sublayer 530 is also responsible for HARQ operations.

In the control plane, the radio protocol architecture for the UE and eNB is substantially the same for the physical layer 510 and the L2 layer 520 with the exception that there is no header compression function for the control plane. The control plane also includes a radio resource control (RRC) sublayer 560 in Layer 3 (L3 layer). The RRC sublayer 560 is responsible for obtaining radio resources (e.g., radio bearers) and for configuring the lower layers using RRC signaling between the eNB and the UE.

As indicated above, FIG. 5 is provided as an example. Other examples are possible and may differ from what was described above in connection with FIG. 5.

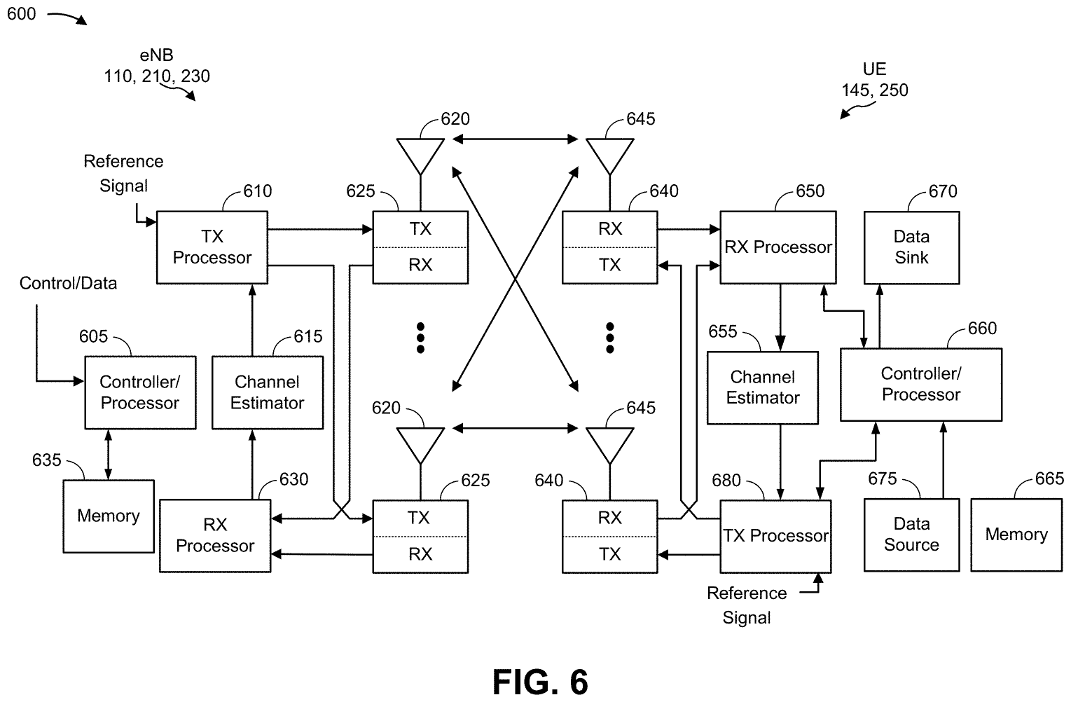

FIG. 6 is a diagram illustrating example components 600 of eNB 110, 210, 230 and UE 145, 250 in an access network, in accordance with various aspects of the present disclosure. As shown in FIG. 6, eNB 110, 210, 230 may include a controller/processor 605, a transmitter (TX) processor 610, a channel estimator 615, an antenna 620, a transmitter 625TX, a receiver 625RX, a receiver (RX) processor 630, and a memory 635. As further shown in FIG. 6, UE 145, 250 may include a receiver RX 640RX, for example, of a transceiver TX/RX 640, a transmitter TX 640TX, for example, of a transceiver TX/RX 640, an antenna 645, an RX processor 650, a channel estimator 655, a controller/processor 660, a memory 665, a data sink 670, a data source 675, and a TX processor 680.

In the DL, upper layer packets from the core network are provided to controller/processor 605. The controller/processor 605 implements the functionality of the L2 layer. In the DL, the controller/processor 605 provides header compression, ciphering, packet segmentation and reordering, multiplexing between logical and transport channels, and radio resource allocations to the UE 145, 250 based, at least in part, on various priority metrics. The controller/processor 605 is also responsible for HARQ operations, retransmission of lost packets, and signaling to the UE 145, 250.

The TX processor 610 implements various signal processing functions for the L1 layer (e.g., physical layer). The signal processing functions includes coding and interleaving to facilitate forward error correction (FEC) at the UE 145, 250 and mapping to signal constellations based, at least in part, on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 615 may be used to determine the coding and modulation scheme, as well as for spatial processing. The channel estimate may be derived from a reference signal and/or channel condition feedback transmitted by the UE 145, 250. Each spatial stream is then provided to a different antenna 620 via a separate transmitter TX 640TX, for example, of transceiver TX/RX 625. Each such transmitter TX 640TX modulates an RF carrier with a respective spatial stream for transmission.

At the UE 145, 250, each receiver RX 640RX, for example, of a transceiver TX/RX 640 receives a signal through its respective antenna 645. Each such receiver RX 640RX recovers information modulated onto an RF carrier and provides the information to the receiver (RX) processor 650. The RX processor 650 implements various signal processing functions of the L1 layer. The RX processor 650 performs spatial processing on the information to recover any spatial streams destined for the UE 145, 250. If multiple spatial streams are destined for the UE 145, 250, the spatial streams may be combined by the RX processor 650 into a single OFDM symbol stream. The RX processor 650 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 110, 210, 230. These soft decisions may be based, at least in part, on channel estimates computed by the channel estimator 655. The soft decisions are then decoded and deinterleaved to recover the data and control signals that were originally transmitted by the eNB 110, 210, 230 on the physical channel. The data and control signals are then provided to the controller/processor 660.

The controller/processor 660 implements the L2 layer. The controller/processor 660 can be associated with a memory 665 that stores program codes and data. The memory 665 may include a non-transitory computer-readable medium. In some aspects, the memory 665 may store a tracking area identifier, associated with a tracking area update, that can be used to determine whether a tracking area is out of synchronization (e.g., whether the tracking area the UE associates with the UE does or may not match the tracking area the network associates with the UE). In the UL, the controller/processor 660 provides demultiplexing between transport and logical channels, packet reassembly, deciphering, header decompression, control signal processing to recover upper layer packets from the core network. The upper layer packets are then provided to a data sink 670, which represents all the protocol layers above the L2 layer. Various control signals may also be provided to the data sink 670 for L3 processing. The controller/processor 660 is also responsible for error detection using a positive acknowledgement (ACK) and/or negative acknowledgement (NACK) protocol to support HARQ operations.

In the UL, a data source 675 is used to provide upper layer packets to the controller/processor 660. The data source 675 represents all protocol layers above the L2 layer. Similar to the functionality described in connection with the DL transmission by the eNB 110, 210, 230, the controller/processor 660 implements the L2 layer for the user plane and the control plane by providing header compression, ciphering, packet segmentation and reordering, and multiplexing between logical and transport channels based, at least in part, on radio resource allocations by the eNB 110, 210, 230. The controller/processor 660 is also responsible for HARQ operations, retransmission of lost packets, and signaling to the eNB 110, 210, 230.

Channel estimates derived by a channel estimator 655 from a reference signal or feedback transmitted by the eNB 110, 210, 230 may be used by the TX processor 680 to select the appropriate coding and modulation schemes, and to facilitate spatial processing. The spatial streams generated by the TX processor 680 are provided to different antenna 645 via separate transmitters TX, for example, of transceivers TX/RX 640. Each transmitter TX 640TX, for example, of transceiver TX/RX 640 modulates a radio frequency (RF) carrier with a respective spatial stream for transmission.

The UL transmission is processed at the eNB 110, 210, 230 in a manner similar to that described in connection with the receiver function at the UE 145, 250. Each receiver RX 640RX, for example, of transceiver TX/RX 625 receives a signal through its respective antenna 620. Each receiver RX 640RX, for example, of transceiver TX/RX 625 recovers information modulated onto an RF carrier and provides the information to a RX processor 630. The RX processor 630 may implement the L1 layer.

The controller/processor 605 implements the L2 layer. The controller/processor 605 can be associated with a memory 635 that stores program code and data. The memory 635 may be referred to as a computer-readable medium. In the UL, the controller/processor 605 provides demultiplexing between transport and logical channels, packet reassembly, deciphering, header decompression, control signal processing to recover upper layer packets from the UE 145, 250. Upper layer packets from the controller/processor 605 may be provided to the core network. The controller/processor 605 is also responsible for error detection using an ACK and/or NACK protocol to support HARQ operations.

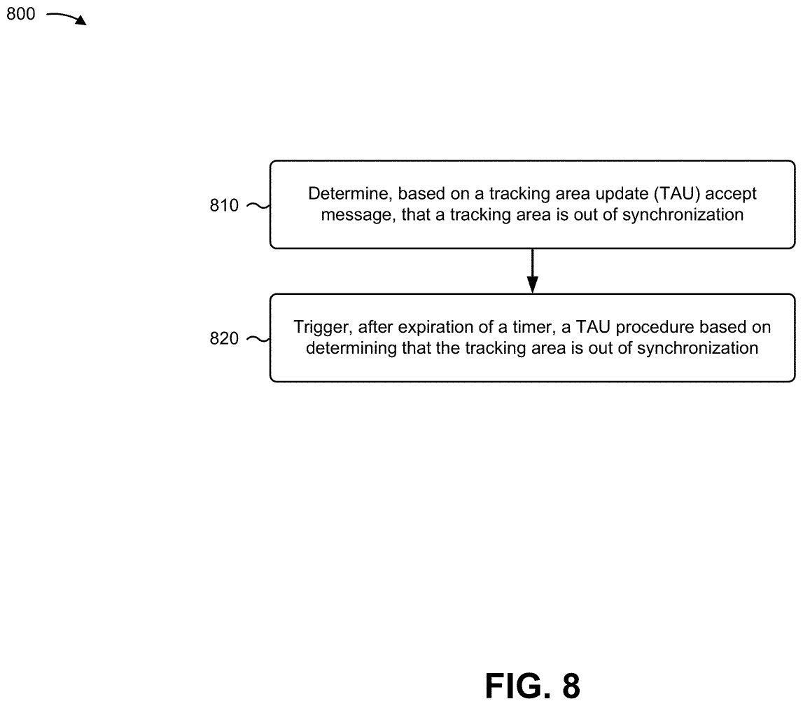

One or more components of UE 145, 250 may be configured to trigger, after expiration of a timer, a tracking area update procedure based on determining that a tracking area is out of synchronization, as described in more detail elsewhere herein. For example, the controller/processor 660 and/or other processors and modules of UE 145, 250 may perform or direct operations of, for example, process 800 of FIG. 8 and/or other processes, as described herein. In some aspects, one or more of the components shown in FIG. 6 may be employed to perform process 800 of FIG. 8 and/or other processes for the techniques described herein.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of components (e.g., one or more components) shown in FIG. 6 may perform one or more functions described as being performed by another set of components shown in FIG. 6.

As described in more detail below, a wireless communication device, which may correspond to UE 145, 250, may determine, based on a tracking area update accept message, that a tracking area is out of synchronization. The wireless communication device may trigger a timer based on determining that the tracking area is out of synchronization. The wireless communication device may trigger, after expiration of the timer, a tracking area update procedure based on determining that the tracking area is out of synchronization, which may cause the wireless communication device to receive another tracking area update accept message and synchronize the tracking area based on receiving the other tracking area update accept message. In this way, UE 145, 250 may reduce a likelihood of a missed page and/or degraded network performance relative to permitting the tracking area to remain out of synchronization.

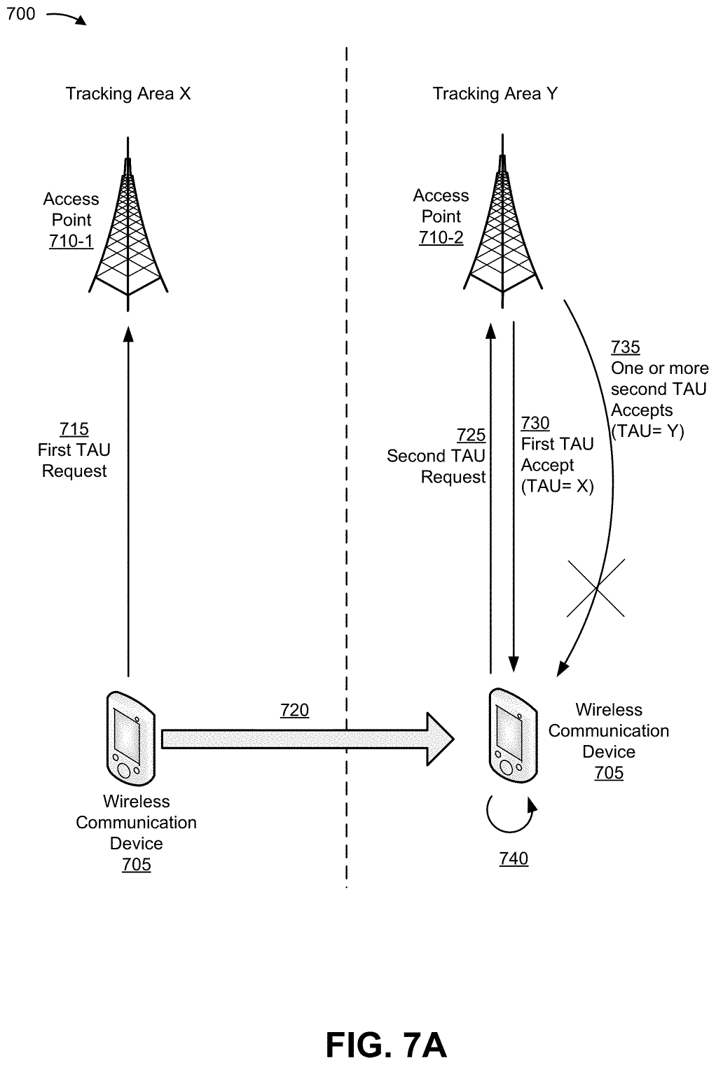

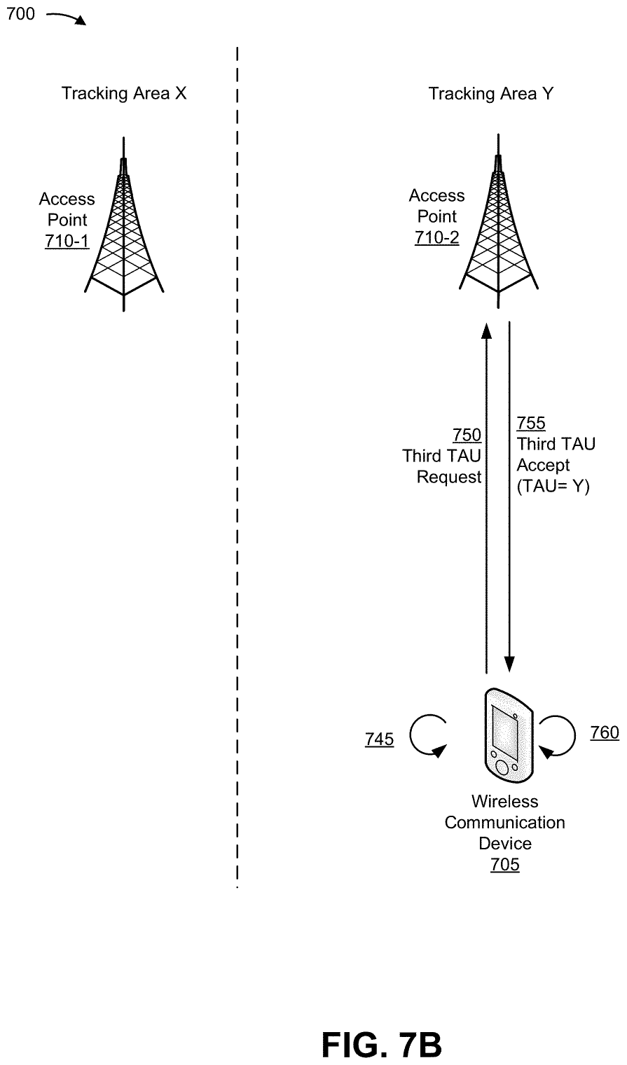

FIGS. 7A and 7B are diagrams illustrating an example 700 of triggering a tracking area update procedure based on determining that a tracking area is out of synchronization, in accordance with various aspects of the present disclosure.

As shown in FIG. 7A, example 700 may include a wireless communication device 705 (e.g., a UE, such as UE 145, 250) and a set of access points 710-1 and 710-2 (e.g., a set of eNBs, such as a set of eNBs 110, 210, 230), which may be associated with a set of tracking areas, such as Tracking Area X and Tracking Area Y. For example, access point 710-1 may be associated with Tracking Area X, and access point 710-2 may be associated with Tracking Area Y. Wireless communication device 705 may, when located in Tracking Area X, transmit a first tracking area update (TAU) request to access point 710-1 to maintain tracking area synchronization. As shown by reference number 720, after transmitting the first tracking area update request message and before receiving a first tracking area update accept message as a response, wireless communication device 705 may move to and/or transfer to Tracking Area Y. For example, wireless communication device 705 may hand off from access point 710-1 to access point 710-2.

As further shown in FIG. 7A, and by reference number 725, wireless communication device 705 may transmit a second tracking area update request message toward access point 710-2 to maintain tracking area synchronization. As shown by reference number 730, wireless communication device 705 may receive the first tracking area update accept message, which is associated with Tracking Area X, and may accept the first tracking area update accept message. This may cause wireless communication device 705 to terminate a tracking area update procedure based on accepting the first tracking area update accept message. For example, wireless communication device 705 may transfer from a protocol state associated with the tracking area update to another protocol state not associated with the tracking area update.

As further shown in FIG. 7A, and by reference number 735, wireless communication device 705 may receive one or more second tracking area update accept messages, which are associated with Tracking Area Y, and may reject the one or more second tracking area update accept messages based on terminating the tracking area update procedure and entering the other protocol state. For example, wireless communication device 705 may transmit a message toward access point 710-2 indicating that the one or more second tracking area update accept messages are of a type (e.g., a tracking area update accept type of message) not compatible with the protocol state of wireless communication device 705.

As further shown in FIG. 7A, and by reference number 740, wireless communication device 705 may determine that a tracking area is out of synchronization based on a tracking area identifier of the first tracking area update accept message. For example, wireless communication device 705 may determine that a first tracking area identifier of the first tracking area update accept message, which identifies Tracking Area X, does not match a second tracking area identifier of a SIB1 signaling message, which identifies Tracking Area Y, received by wireless communication device 705 when transferring tracking areas. In this case, wireless communication device 705 may initiate a timer. Expiration of the timer may be associated with causing wireless communication device 705 to trigger a tracking area update procedure. In some aspects, wireless communication device 705 may configure the timer to expire after approximately zero seconds, thereby causing the tracking area update procedure to be triggered with a reduced period of the tracking area being out of synchronization relative to utilizing a timer configured with a longer period of time.

As shown in FIG. 7B, and by reference number 745, based on expiration of the timer, wireless communication device 705 may initiate a tracking area update procedure to synchronize the tracking area. In this case, wireless communication device 705 may alter the protocol state to being in a protocol state where wireless communication device 705 is configured to receive a tracking area update accept message. As shown by reference number 750, wireless communication device 705 transmits a third tracking area update request message to trigger the tracking area update procedure. As shown by reference number 755, wireless communication device 705 receives a third tracking area update accept message from access point 710-2 (e.g., based on an MME, such as MME 120, providing the third tracking area update accept message to access point 710-2). Wireless communication device 705 accepts the third tracking area update accept message. This may cause the tracking area to be in synchronization for wireless communication device 705, as shown by reference number 760. In this way, UE 145, 250, 705 synchronizes a tracking area, thereby reducing a likelihood of UE 145, 250, 705 missing a paging message and/or experiencing degraded network performance relative to permitting the tracking area to remain out of synchronization.

As indicated above, FIGS. 7A and 7B are provided as an example. Other examples are possible and may differ from what was described with respect to FIGS. 7A and 7B.

FIG. 8 is a diagram illustrating an example process 800 performed, for example, by a wireless communication device (e.g., a UE 145, 250, 705), in accordance with various aspects of the present disclosure. Example process 800 is an example where a wireless communication device triggers a tracking area update procedure based on determining that a tracking area is out of synchronization.

As shown in FIG. 8, in some aspects, process 800 may include determining, based on a tracking area update (TAU) accept message (e.g., from or via an eNB and/or a core network entity, such as MME 120), that a tracking area is out of synchronization (block 810). For example, a wireless communication device may determine, based on the tracking area update accept message, that the tracking area is out of synchronization. In some aspects, the wireless communication device may receive the tracking area accept message after moving and/or transferring from an access point associated with a first tracking area to an access point associated with a second tracking area. For example, based on transmitting a first tracking area update request message (e.g., to or via an eNB and/or a core network entity, such as MME 120) when in the first tracking area, transferring to the second tracking area, and transmitting a second tracking area update request message when in the second tracking area, the wireless communication device may receive the tracking area update accept message as a response to the first tracking area update request message.

In some aspects, the wireless communication device may determine that the tracking area is out of synchronization based on a tracking area identifier associated with the tracking area update accept message. For example, the wireless communication device may determine that a first tracking area identifier associated with the tracking area update accept message does not match a second tracking area identifier determined based on a system information block message (e.g., SIB1), such as a primary tracking area identifier in SIB 1. In this case, the wireless communication device may determine that the tracking area update accept message relates to an incorrect tracking area and that the tracking area is out of synchronization.

In some aspects, the wireless communication device may trigger a timer based on determining that the tracking area is out of synchronization. For example, the wireless communication device may activate a timer, expiration of which is associated with triggering a tracking area update procedure. In some aspects, the timer may be configured to expire after a particular time, such as after approximately zero seconds (e.g., configured to approximately zero seconds). In this way, the wireless communication device reduces and/or minimizes an amount of time for which the tracking area is out of synchronization by causing the tracking area update procedure to be triggered with little or no delay after determining that the tracking area is out of synchronization. In some aspects, the timer may be configured to expire after an amount of time that is greater than approximately zero seconds. In this way, when the wireless communication device is repeatedly transferring between tracking areas, the wireless communication device avoids transmitting excessive and/or fruitless tracking area update request messages, thereby reducing network traffic relative to transmitting a tracking area update request without delay after determining that the tracking area is out of synchronization.

As shown in FIG. 8, in some aspects, process 800 may include triggering, for example, after expiration of a timer, a TAU procedure based on determining that the tracking area is out of synchronization (block 820). For example, the wireless communication device may trigger, after expiration of the timer, the tracking area update procedure based on determining that the tracking area is out of synchronization. In some aspects, the wireless communication device may transmit a tracking area update request message to trigger the tracking area update procedure. For example, the wireless communication device may transmit the tracking area update request message and may enter a protocol state that permits the wireless communication device to receive a tracking area update accept message. In this case, the wireless communication device may receive a tracking area update accept message, which is associated with a tracking area of the wireless communication device, based on transmitting the tracking area update request message. In this way, the wireless communication device synchronizes the tracking area based on the wireless communication device receiving the tracking area update accept message.

In some aspects, the wireless communication device may trigger the tracking area update procedure based on one or more measurements. For example, the wireless communication device may perform one or more reference signal received quality (RSRQ) value measurements and/or one or more reference signal received power (RSRP) value measurements. In this case, the wireless communication device may trigger the tracking area update based on at least one of the one or more RSRQ measurements satisfying a threshold (e.g., an RSRQ threshold) and/or the one or more RSRP measurements satisfying a threshold (e.g., an RSRP threshold). In this way, the wireless communication device reduces a likelihood that the wireless communication device transmits excessive and/or fruitless tracking area update requests when, for example, the wireless communication device is repeatedly transferring tracking areas as a result of a poor signal quality and/or poor signal power. In some aspects, the wireless communication device may trigger the tracking area update procedure based on both a timer expiring and a measurement satisfying a threshold.

Additionally, or alternatively, process 800 may include receiving another TAU accept message based on triggering the TAU procedure and process 800 may include synchronizing the tracking area for the wireless communication device based on receiving the other TAU message.

Additionally, or alternatively, process 800 may include triggering the timer after determining that the tracking area is out of synchronization, process 800 may include determining that a threshold period of time has expired based on the timer, wherein the threshold period of time is associated with expiration of the timer, and process 800 may include triggering the TAU procedure based on determining that the threshold period of time has expired.

Additionally, or alternatively, process 800 may include determining that the tracking area of the wireless communication device is out of synchronization based on determining that a first tracking area identifier does not match a second tracking area identifier, where the first tracking area identifier is associated with the TAU accept message, and where the second tracking area identifier is determined based on a system information block type 1 (SIB1) message.

Additionally, or alternatively, process 800 may include transmitting a TAU request message to trigger the TAU procedure.

Additionally, or alternatively, process 800 may include receiving another TAU accept message based on transmitting the TAU request message, where the other TAU accept message permits or enables synchronization of the wireless communication device and a network.

Additionally, or alternatively, process 800 may include determining that a reference signal received quality (RSRQ) value satisfies a threshold and/or a reference signal received power (RSRP) value satisfies a threshold and process 800 may include triggering the TAU procedure based on such determining.

Additionally, or alternatively, the timer may be configured to expire at approximately zero seconds.

Additionally, or alternatively, process 800 may include receiving the TAU accept message after transferring from an access point associated with a first tracking area to a second access point associated with a second tracking area.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

Techniques and apparatuses described herein may cause a wireless communication device to trigger a tracking area update procedure based on determining that a tracking area is out of synchronization. This may improve a performance of the wireless communication device by reducing a likelihood of missed pages and/or degraded network performance relative to the tracking area remaining out of synchronization.

The foregoing disclosure provides illustration and description, but is not intended to be exhaustive or to limit the aspects to the precise form disclosed. Modifications and variations are possible in light of the above disclosure or may be acquired from practice of the aspects.

As used herein, the term component is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

It will be apparent that systems and/or methods, described herein, may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of possible aspects. In fact, many of these features may be combined in ways not specifically recited in the claims and/or disclosed in the specification. Although each dependent claim listed below may directly depend on only one claim, the disclosure of possible aspects includes each dependent claim in combination with every other claim in the claim set. A phrase referring to “at least one of” a list of items refers to any combination of those items, including single members. For example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the term “one” or similar language is used. Also, as used herein, the terms “has,” “have,” “having,” and/or the like are intended to be open-ended terms. Further, the phrase “based on” is intended to mean, “based, at least in part, on” unless explicitly stated otherwise.

What is claimed is:

1. A method of wireless communication, comprising:
determining, by a wireless communication device and based on a tracking area update (TAU) accept message, that a tracking area is out of synchronization; and
triggering, by the wireless communication device and after expiration of a timer, a TAU procedure based on determining that the tracking area is out of synchronization.

2. The method of claim 1, further comprising:
receiving another TAU accept message based on triggering the TAU procedure; and
synchronizing the tracking area for the wireless communication device based on receiving the other TAU accept message.

3. The method of claim 1, further comprising:
triggering the timer after determining that the tracking area is out of synchronization;
determining that a threshold period of time has expired based on the timer, the threshold period of time being associated with expiration of the timer; and
triggering the TAU procedure based on determining that the threshold period of time has expired.

4. The method of claim 1, wherein:
determining that a tracking area is out of synchronization includes determining that the tracking area is out of synchronization based on determining that a first tracking area identifier does not match a second tracking area identifier,
the first tracking area identifier being associated with the TAU accept message, and
the second tracking area identifier being determined based on a system information block type 1 (SIB1) message.

5. The method of claim 1, further comprising:
transmitting a TAU request message to trigger the TAU procedure.

6. The method of claim 5, further comprising:
receiving another TAU accept message based on transmitting the TAU request message,
the other TAU accept message enabling tracking area synchronization of the wireless communication device and a network.

7. The method of claim 1, further comprising:
determining at least one of a reference signal received quality (RSRQ) value satisfies a RSRQ threshold or a reference signal received power (RSRP) value satisfies a RSRP threshold; and
triggering the TAU procedure based on the determining.

8. The method of claim 1, wherein the timer is configured to approximately zero seconds.

9. The method of claim 1, further comprising:
receiving the TAU accept message after transferring from a first access point associated with a first tracking area to a second access point associated with a second tracking area.

10. A wireless communication device, comprising:
one or more processors configured to:
determine, based on a tracking area update (TAU) accept message, that a tracking area is out of synchronization; and
trigger, after expiration of a timer, a TAU procedure based on determining that the tracking area is out of synchronization.

11. The wireless communication device of claim 10, wherein the one or more processors are further configured to:
receive another TAU accept message based on triggering the TAU procedure; and
synchronize the tracking area for the wireless communication device based on receiving the other TAU accept message.

12. The wireless communication device of claim 10, wherein the one or more processors are further configured to:
trigger the timer after determining that the tracking area is out of synchronization;
determine that a threshold period of time has expired based on the timer, the threshold period of time being associated with expiration of the timer; and
trigger the TAU procedure based on determining that the threshold period of time has expired.

13. The wireless communication device of claim 10, wherein the one or more processors are further configured to:
determine that the tracking area of the wireless communication device is out of synchronization based on determining that a first tracking area identifier does not match a second tracking area identifier,
the first tracking area identifier being associated with the TAU accept message, and
the second tracking area identifier being determined based on a system information block type 1 (SIB1) message.

14. The wireless communication device of claim 10, wherein the one or more processors are further configured to:
transmit a TAU request message to trigger the TAU procedure.

15. The wireless communication device of claim 14, wherein the one or more processors are further configured to:
receive another TAU accept message based on transmitting the TAU request message,
the other TAU accept message enabling tracking area synchronization of the wireless communication device and a network.

16. The wireless communication device of claim 10, wherein the one or more processors are further configured to:
determine at least one of a reference signal received quality (RSRQ) value satisfies a RSRQ threshold or a reference signal received power (RSRP) value satisfies a RSRP threshold; and
trigger the TAU procedure based on the determining.

17. The wireless communication device of claim 10, wherein the timer is configured to approximately zero seconds.

18. The wireless communication device of claim 10, wherein the one or more processors are further configured to:
receive the TAU accept message after transferring from a first access point associated with a first tracking area to a second access point associated with a second tracking area.

19. A non-transitory computer-readable medium storing one or more instructions for wireless communication, the one or more instructions comprising:
one or more instructions that, when executed by one or more processors of a wireless communication device, cause the one or more processors to:
determine, based on a tracking area update (TAU) accept message, that a tracking area is out of synchronization; and
trigger, after expiration of a timer, a TAU procedure based on determining that the tracking area is out of synchronization.

20. The non-transitory computer-readable medium of claim 19, wherein the one or more instructions, when executed by the one or more processors, further cause the one or more processors to:
receive another TAU accept message based on triggering the TAU procedure; and
synchronize the tracking area for the wireless communication device based on receiving the other TAU accept message.

21. The non-transitory computer-readable medium of claim 19, wherein the one or more instructions, when executed by the one or more processors, further cause the one or more processors to:
trigger the timer after determining that the tracking area is out of synchronization;
determine that a threshold period of time has expired based on the timer, the threshold period of time being associated with expiration of the timer; and
trigger the TAU procedure based on determining that the threshold period of time has expired.

22. The non-transitory computer-readable medium of claim 19, wherein the one or more instructions, when executed by the one or more processors, further cause the one or more processors to:
determine that the tracking area of the wireless communication device is out of synchronization based on determining that a first tracking area identifier does not match a second tracking area identifier,
the first tracking area identifier being associated with the TAU accept message, and
the second tracking area identifier being determined based on a system information block type 1 (SIB1) message.

23. The non-transitory computer-readable medium of claim 19, wherein the one or more instructions, when executed by the one or more processors, further cause the one or more processors to:
transmit a TAU request message to trigger the TAU procedure.

24. The non-transitory computer-readable medium of claim 23, wherein the one or more instructions, when executed by the one or more processors, further cause the one or more processors to:
receive another TAU accept message based on transmitting the TAU request message,
the other TAU accept message enabling tracking area synchronization of the wireless communication device and a network.

25. The non-transitory computer-readable medium of claim 19, wherein the one or more instructions, when executed by the one or more processors, further cause the one or more processors to:
determine at least one of a reference signal received quality (RSRQ) value satisfies a RSRQ threshold or a reference signal received power (RSRP) value satisfies a RSRP threshold; and
trigger the TAU procedure based on the determining.

26. The non-transitory computer-readable medium of claim 19, where the timer is configured to approximately zero seconds.

27. The non-transitory computer-readable medium of claim 19, wherein the one or more instructions, when executed by the one or more processors, further cause the one or more processors to:
receive the TAU accept message after transferring from a first access point associated with a first tracking area to a second access point associated with a second tracking area.

28. An apparatus for wireless communication, comprising:
means for determining, based on a tracking area update (TAU) accept message, that a tracking area is out of synchronization; and
means for triggering, after expiration of a timer, a TAU procedure based on determining that the tracking area is out of synchronization.

29. The apparatus of claim 28, further comprising:
means for receiving another TAU accept message based on triggering the TAU procedure; and
means for synchronizing the tracking area for the apparatus based on receiving the other TAU accept message.

30. The apparatus of claim 28, wherein the means for determining that a tracking area is out of synchronization includes means for determining that the tracking area is out of synchronization based on determining that a first tracking area identifier does not match a second tracking area identifier,
the first tracking area identifier being associated with the TAU accept message, and
the second tracking area identifier being determined based on a system information block type 1 (SIB1) message.
